(19) United States
(12) Patent Application Publication
(10) Pub. No.: US 2024/0015575 A1
(43) Pub. Date: Jan. 11, 2024

(54) COORDINATING WIRELESS TRANSMISSIONS USING PUNCTURING

(71) Applicant: Cisco Technology, Inc., San Jose, CA (US)

(72) Inventors: Malcolm M. SMITH, Richardson, TX (US); Indermeet S. GANDHI, San Jose, CA (US)

(21) Appl. No.: 18/052,892

(22) Filed: Nov. 4, 2022

Related U.S. Application Data
(60) Provisional application No. 63/368,008, filed on Jul. 8, 2022.

(51) Int. Cl. H04W 28/02

(52) U.S. Cl. CPC H04W 28/0278; H04W 28/0236; H04W 84/12

(57) ABSTRACT

A method includes receiving a first buffer status report from a WiFi access point and receiving a second buffer status report from a first NR-U radio unit. The method also includes scheduling, based at least in part on the first buffer status report and the second buffer status report, both the WiFi access point and the first NR-U radio unit to transmit during a first time slot using a channel. The WiFi access point transmits using a first sub-channel of the channel, and the first NR-U radio unit transmits using a second sub-channel of the channel different from the first sub-channel.

### CROSS-REFERENCE TO RELATED APPLICATIONS

This application claims benefit of co-pending U.S. provisional patent application Ser. No. 63/368,008 filed Jul. 8, 2022. The aforementioned related patent application is herein incorporated by reference in its entirety.

### TECHNICAL FIELD

Embodiments presented in this disclosure generally relate to wireless communications. More specifically, embodiments disclosed herein relate to coordinating wireless transmissions using puncturing.

### BACKGROUND

In some environments, multiple communication systems may be implemented to provide users different options for connecting wirelessly to the Internet or another network. For example, both wireless fidelity (WiFi) access points and New Radio Unlicensed (NR-U) radio units may be deployed in dense environments to provide users the ability to wirelessly connect over WiFi or 5G.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system.

FIG. 2 illustrates an example controller in the system of FIG. 1.

FIG. 3 illustrates an example of puncturing in the system of FIG. 1.

FIG. 4 illustrates an example of puncturing in the system of FIG. 1.

FIG. 5 illustrates an example of puncturing in the system of FIG. 1.

FIG. 6 is a flowchart of an example method performed in the system of FIG. 1.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

According to an embodiment, a method includes receiving a first buffer status report from a WiFi access point and receiving a second buffer status report from a first NR-U radio unit. The method also includes scheduling, based at least in part on the first buffer status report and the second buffer status report, both the WiFi access point and the first NR-U radio unit to transmit during a first time slot using a channel. The WiFi access point transmits using a first sub-channel of the channel, and the first NR-U radio unit transmits using a second sub-channel of the channel different from the first sub-channel.

According to another embodiment, an apparatus includes a memory and a processor communicatively coupled to the memory. The processor receives a first buffer status report from a WiFi access point and receives a second buffer status report from a first NR-U radio unit. The processor also schedules, based at least in part on the first buffer status report and the second buffer status report, both the WiFi access point and the first NR-U radio unit to transmit during a first time slot using a channel. The WiFi access point transmits using a first sub-channel of the channel, and the first NR-U radio unit transmits using a second sub-channel of the channel different from the first sub-channel.

According to another embodiment, a non-transitory computer readable medium stores instructions, that when executed by a processor, cause the processor to receive a first buffer status report from a WiFi access point and receive a second buffer status report from a first NR-U radio unit. The processor also schedules, based at least in part on the first buffer status report and the second buffer status report, both the WiFi access point and the first NR-U radio unit to transmit during a first time slot using a channel. The WiFi access point transmits using a first sub-channel of the channel and the first NR-U radio unit transmits using a second sub-channel of the channel different from the first sub-channel.

### EXAMPLE EMBODIMENTS

In some environments, both wireless fidelity (WiFi) access points and New Radio Unlicensed (NR-U) radio units may be deployed in dense environments to provide users the ability to wirelessly connect over WiFi or 5G. The WiFi access points and the NR-U radio units may communicate using overlapping channels. In existing systems, when the WiFi access points and the NR-U radio units transmit over the same channels, collisions occur resulting in suboptimal network performance.

The present disclosure describes a system that coordinates the transmissions of a WiFi access point and a NR-U radio unit. The system includes a controller that uses buffer status reports from the WiFi access point and the NR-U radio unit to schedule the transmissions from the WiFi access point and the NR-U radio unit. When these transmissions are scheduled to occur in the same time slot and using the same channel, the controller may schedule the NR-U radio unit to transmit using a portion of the sub-channels (e.g., some of the 20 MHz sub-channels) of the channel. The remaining sub-channels are allotted to the WiFi access point. When the NR-U radio unit does not need to transmit, all sub-channels may be allocated to the WiFi access point. This technique may be referred to as puncturing. As a result, the controller allows both the WiFi access point and the NR-U radio unit to transmit using the same channel during the same time slot without causing unwanted collisions, which improves network performance in certain embodiments.

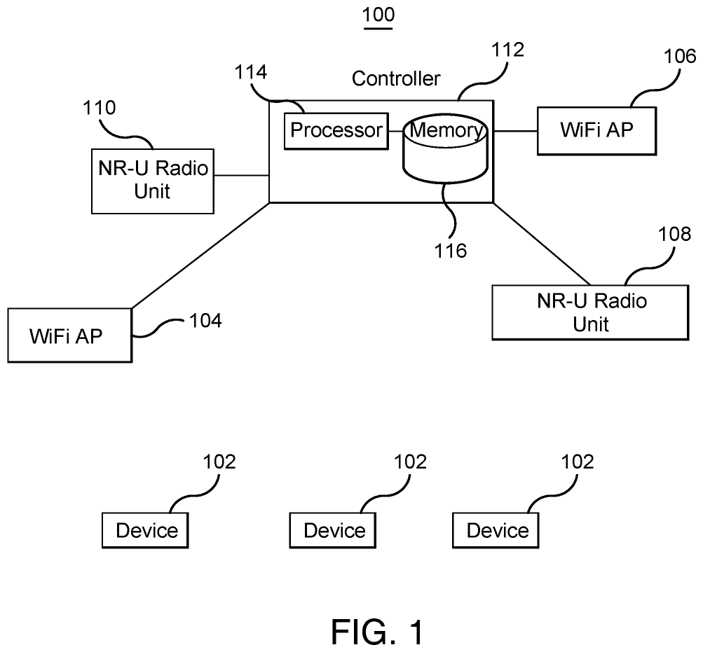

FIG. 1 illustrates an example system 100. As seen in FIG. 1, the system 100 includes one or more devices 102, a WiFi access point 104, a WiFi access point 106, a NR-U radio unit 108, a NR-U radio unit 110, and a controller 112. Generally, the devices 102 connect to the Internet or another network through one or more of the WiFi access points 104 and 106 or the NR-U radio units 108 and 110. The controller 112 coordinates the transmissions from the WiFi access points 104 and 106 and the NR-U radio units 108 and 110. In particular embodiments, the controller 112 coordinates the transmissions such that the WiFi access points 104 and 106 and the NR-U radio units 108 and 110 may transmit during the same timeslot and using the same channel without causing unwanted collisions, which improves network performance.

The devices 102 may be any suitable devices that connect to the Internet or other networks through the WiFi access points 104 and 106 or the NR-U radio units 108 and 110. The devices 102 may transmit messages to and receive messages from the WiFi access points 104 and 106 or the NR-U radio units 108 and 110. For example, a device 102 may form a WiFi connection with the WiFi access point 104. The device 102 may then transmit messages or receive messages over this WiFi connection. As another example, the device 102 may form a 5G connection with the NR-U radio unit 108. The device 102 may then transmit messages or receive messages over this 5G connection.

The device 102 is any suitable device for communicating with components of the system 100. As an example and not by way of limitation, the device 102 may be a computer, a laptop, a wireless or cellular telephone, an electronic notebook, a personal digital assistant, a tablet, or any other device capable of receiving, processing, storing, or communicating information with other components of the system 100. The device 102 may be a wearable device such as a virtual reality or augmented reality headset, a smart watch, or smart glasses. The device 102 may also include a user interface, such as a display, a microphone, keypad, or other appropriate terminal equipment usable by a user. The device 102 may include a hardware processor, memory, or circuitry configured to perform any of the functions or actions of the device 102 described herein. For example, a software application designed using software code may be stored in the memory and executed by the processor to perform the functions of the device 102.

The WiFi access points 104 and 106 facilitate WiFi communications with one or more of the devices 102. For example, the WiFi access points 104 and 106 may transmit messages to the devices 102 over a WiFi connection with the devices 102. Additionally, the WiFi access points 104 and 106 may receive messages from the devices 102 over the WiFi connection. The WiFi access points 104 and 106 may generate and communicate buffer status reports to the controller 112 to notify the controller 112 of traffic awaiting transmission at the WiFi access points 104 and 106. If these buffers status reports indicate a large amount of traffic is awaiting transmission at the WiFi access points 104 and 106, the controller 112 may schedule more transmission opportunities for the WiFi access points 104 and 106 to reduce the traffic load at the WiFi access points 104 and 106.

The NR-U radio units 108 and 110 facilitate 5G communications with connected devices 102. For example, the NR-U radio units 108 and 110 may transmit messages to connected devices 102 over a 5G connection. Additionally, the NR-U radio units 108 and 110 may receive messages from the devices 102 over the 5G connection. The NR-U radio units 108 and 110 may generate and communicate buffer status reports to the controller 112 to notify the controller 112 of traffic awaiting transmission at the NR-U radio units 108 and 110. If the buffer status reports indicate a large amount of traffic is awaiting transmission at the NR-U radio units 108 and 110, the controller 112 may schedule more transmission opportunities for the NR-U radio units 108 and 110 to reduce the traffic load at the NR-U radio units 108 and 110.

The WiFi access points 104 and 106 and the NR-U radio units 108 and 110 may transmit messages using the same channel. When the WiFi access points 104 and 106 and the NR-U radio units 108 and 110 transmit using the same channel during the same timeslots unwanted collisions may occur. These collisions may negatively impact the network performance of the system 100. For example, the transmissions from the NR-U radio units 108 and 110 may interfere with transmissions from the WiFi access points 104 and 106, and vice versa. As a result, the devices 102 may experience difficulty receiving the transmitted messages from the WiFi access points 104 and 106 and the NR-U radio units 108 and 110.

The controller 112 coordinates the transmissions from the WiFi access points 104 and 106 and the NR-U radio units 108 and 110 to reduce unwanted collisions in the system 100. In certain embodiments, when the controller 112 determines that the WiFi access points 104 and 106 and the NR-U radio units 108 and 110 are transmitting using the same channel during the same timeslot, the controller 112 may instruct the NR-U radio units 108 and 110 to use certain subchannels of the channel to transmit messages (which may also be referred to as puncturing), and the controller 112 may instruct the WiFi access points 104 and 106 to use the remaining subchannels to transmit. In this manner, the controller 112 allows the WiFi access points 104 and 106 and the NR-U radio units 108 and 110 to share the channel while reducing unwanted collisions between the WiFi access points 104 and 106 and the NR-U radio units 108 and 110. As seen in FIG. 1, the controller 112 includes a processor 114 and a memory 116, which may perform the actions or functions of the controller 112 described herein.

The processor 114 is any electronic circuitry, including, but not limited to one or a combination of microprocessors, microcontrollers, application specific integrated circuits (ASIC), application specific instruction set processor (ASIP), and/or state machines, that communicatively couples to memory 116 and controls the operation of the controller 112. The processor 114 may be 8-bit, 16-bit, 32-bit, 64-bit or of any other suitable architecture. The processor 114 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 114 may include other hardware that operates software to control and process information. The processor 114 executes software stored on the memory 116 to perform any of the functions described herein. The processor 114 controls the operation and administration of the controller 112 by processing information (e.g., information received from the devices 102, WiFi access points 104, NR-U radio units 108 and 110, and memory 116). The processor 114 is not limited to a single processing device and may encompass multiple processing devices.

The memory 116 may store, either permanently or temporarily, data, operational software, or other information for the processor 114. The memory 116 may include any one or a combination of volatile or non-volatile local or remote devices suitable for storing information. For example, the memory 116 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 116, a disk, a CD, or a flash drive. In particular embodiments, the software may include an application executable by the processor 114 to perform one or more of the functions described herein.

The controller 112 may coordinate the transmissions from the WiFi access points 104 and 106 and the NR-U radio units 108 and 110 using any suitable metrics. For example, the controller 112 may receiver buffer status reports from the WiFi access points 104 and 106 and the NR-U radio units 108 and 110. From these buffer status reports, the controller 112 may determine the amount of traffic awaiting transmission at the WiFi access points 104 and 106 and the NR-U radio units 108 and 110. The controller 112 may then coordinate the transmissions from the WiFi access points 104 and 106 and the NR-U radio units 108 and 110 to alleviate the traffic load. For example, if the NR-U radio units 108 and 110 are holding a large amount of traffic, then the controller 112 may instruct the NR-U radio units 108 and 110 to transmit during the same timeslots as the WiFi access points 104 and 106 using the same channel. The controller 112 may instruct the NR-U radio units 108 and 110 to use some of the subchannels of the channel to transmit the messages. Additionally, the controller 112 may instruct the WiFi access points 104 and 106 to transmit using the remaining subchannels and to refrain from transmitting using the same subchannels as the NR-U radio units 108 and 110. As a result, the WiFi access points 104 and 106 and the NR-U radio units 108 and 110 share the channel during the timeslot, which reduces unwanted collisions and improves network performance, in certain embodiments.

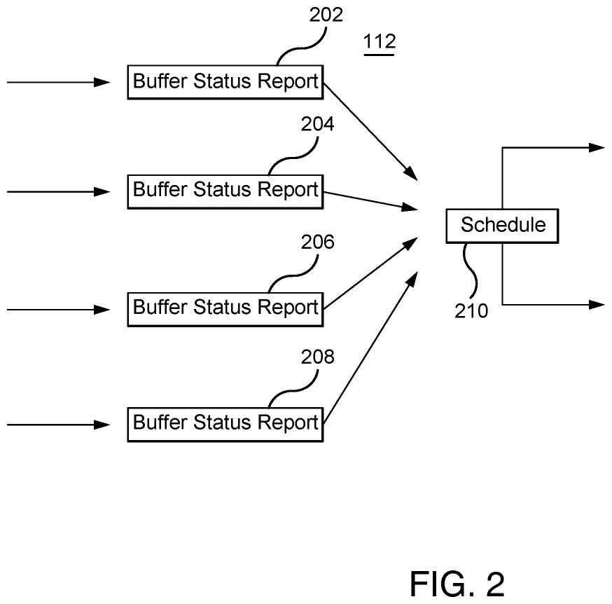

FIG. 2 illustrates an example controller 112 in the system 100 of FIG. 1. As seen in FIG. 2, the controller 112 receives buffer status reports 202, 204, 206, and 208. The buffer status report 202 may have been generated by the WiFi access point 104. The buffer status report 204 may have been generated by the WiFi access point 106. The buffer status report 206 may have been generated by the NR-U radio unit 108. The buffer status report 208 may have been generated by the NR-U radio unit 110. Each of the buffer status reports 202, 204, 206, and 208 may indicate an amount of network traffic awaiting transmission at the corresponding WiFi access point or NR-U radio unit. For example, the buffer status report 202 may indicate an amount of traffic awaiting transmission at the WiFi access point 104. The buffer status report 204 may indicate an amount of traffic awaiting transmission at the WiFi access point 106. The buffer status report 206 may indicate an amount of traffic awaiting transmission at the NR-U radio unit 108. The buffer status report 208 may indicate an amount of traffic awaiting transmission at the NR-U radio unit 110.

In some embodiments, the buffer status reports 202, 204, 206, and 208 are sent to the controller 112 in a synchronized manner (e.g., initiated by a multi access point coordination (MAPc) function). The WiFi access points 104 and 106 and the NR-U radio units 108 and 110 may synchronize the sending of the buffer status reports 202, 204, 206, and 208 to the controller 112.

The controller 112 uses the information in the buffer status reports 202, 204, 206, and 208 to generate a schedule 210. The schedule 210 may indicate the timeslots and channels, or subchannels, to use for transmission. The controller 12 may schedule additional transmissions for components that have a large amount of traffic awaiting transmission, and the controller 112 may schedule fewer transmissions for components that have little or no traffic awaiting transmission. For example, if the buffer status report 206 indicates that the NR-U radio unit 108 is holding a large amount of traffic, the controller 112 may schedule additional transmissions for the NR-U radio unit 108. The controller 112 may schedule these transmissions by instructing the WiFi access points 104 and 106 to refrain from transmitting over particular subchannels and by instructing the NR-U radio unit 108 to transmit using these subchannels. As a result, the NR-U radio unit 108 is allowed to transmit during the same timeslots as the WiFi access points 104 and 106 using different subchannels of the channel, which reduces unwanted collisions with the WiFi access points 104 and 106.

As another example, if the buffer status reports 206 and 208 indicate that the NR-U radio units 108 and 110 have little or no traffic awaiting transmission, and the buffer status report 202 indicates that the WiFi access point 104 has a large amount of traffic awaiting transmission, the controller 112 may schedule additional transmissions for the WiFi access point 104. The controller 112 may instruct the NR-U radio units 108 and 110 to refrain from transmitting during certain timeslots, and the controller 112 may instruct the WiFi access point 104 to transmit using the available subchannels during the timeslot.

The schedule 210 includes the scheduling information for the transmissions. The controller 112 may communicate the schedule 210 to one or more of the WiFi access points 104 and 106 and the NR-U radio units 108 and 110. The WiFi access points 104 and 106 and the NR-U radio units 108 and 110 may then follow the schedule 210 to transmit messages. For example, the NR-U radio units 108 and 110 may transmit messages using particular subchannels during the same timeslots as the WiFi access points 104 and 106. The WiFi access points 104 and 106 may transmit during the timeslot using the remaining subchannels that are not being used by the NR-U radio units 108 and 110. As a result, unwanted collisions between the WiFi access points 104 and 106 and the NR-U radio units 108 and 110 may be reduced.

In some embodiment, the buffer status reports 202, 204, 206, and 208 also indicate the type of traffic awaiting transmission. For example, the buffer status reports 202, 204, 206, and 208 may indicate the amount of latency sensitive traffic (e.g., video traffic) awaiting transmission. The latency sensitive traffic may have a quality of service that should be met. To meet this quality of service, it may be important for the traffic to be transmitted as soon as possible. When the controller 112 determines that latency sensitive traffic is awaiting transmission, the controller 112 may schedule transmission opportunities for the latency sensitive traffic. For example, if the buffer status report 206 indicates that latency sensitive traffic is awaiting transmission at the NR-U radio unit 108, the controller 112 may schedule transmission opportunities for the NR-U radio unit 108. The NR-U radio unit 108 may then transmit during the same timeslot as the WiFi access points 104 and 106 using punctured subchannels of the channel.

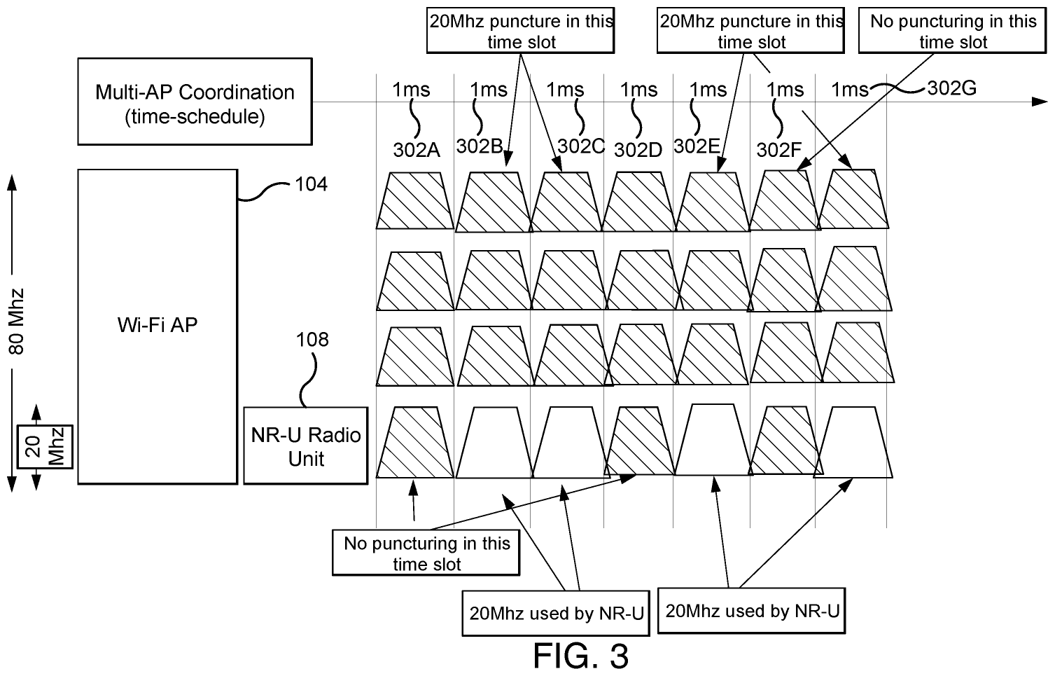

FIG. 3 illustrates an example of puncturing the system 100 of FIG. 1. Generally, puncturing refers to the technique in which the controller 112 reserves certain subchannels of a channel during certain timeslots for particular components of the system 100. In the example of FIG. 3, a 20-megaHertz subchannel of an 80 megaHertz channel is punctured during certain timeslots to allow the NR-U radio unit 108 to transmit. The WiFi access point 104 is allowed to use the remaining 20-megaHertz subchannels during these time slots.

As seen in FIG. 3, the WiFi access point 104 may transmit using an 80-megaHertz channel, while the NR-U radio unit 108 may transmit using a 20-megaHertz subchannel of the 80-megaHertz channel. In this manner, the WiFi access point 104 and the NR-U radio unit 108 may transmit using the same channel. In the example of FIG. 3, the transmissions occur during the timeslots 302A, 302B, 302C, 302D, 302E, 302F, and 302G. Each of the timeslots 302A, 302B, 302C, 302D, 302E, 302F, and 302G are 1-milisecond in duration. The WiFi access point 104 and the NR-U radio unit 108 may transmit during the timeslots 302A, 302B, 302C, 302D, 302E, 302F, and 302G according to the schedule 210 set by the controller 112.

During the timeslots 302A, 302D, and 302F, the WiFi access point 104 may transmit using every 20-megaHertz subchannel of the 8-megaHertz channel (indicated by the trapezoids with hatching in the timeslots 302A, 302D, and 302F). The controller 112 may have determined, based on the amount of traffic awaiting transmission at the WiFi access point 104 and the NR-U radio unit 108, that the NR-U radio unit 108 should not transmit during the timeslots 302A, 302D, and 302F. As a result, the WiFi access point 104 may transmit using every 20-megaHertz subchannel of the 80-megaHertz channel during the timeslots 302A, 302D, and 302F.

The controller 112 may determine that the NR-U radio unit 108 should be allowed to transmit during the timeslots 302B, 302C, 302E, and 302G. In order for the WiFi access point 104 and the NR-U radio unit 108 to share the 80-megaHertz channel during the timeslots 302B, 302C, 302E, and 302G, the controller 112 may instruct the NR-U radio unit 108 to transmit using a 20-megaHertz subchannel of the channel, and the controller 112 may instruct the WiFi access point 104 to transmit using the remaining 20-megaHertz subchannels of the channel. As a result, the NR-U radio unit 108 uses a 20-megaHertz subchannel of the channel to transmit during the timeslots 302B, 302C, 302E, and 302G (indicated by the trapezoids with no hatching in the timeslots 302B, 302C, 302E, and 302G). The WiFi access point 104 uses the remaining three 20-megaHertz subchannels to transmit during the timeslots 302B, 302C, 302E, and 302G (indicated by the trapezoids with hatching in the timeslots 302B, 302C, 302E, and 302G). By allowing the 20-megaHertz subchannel to be punctured, the NR-U radio unit 108 may share the 80-megaHertz channel with the WiFi access point 104 while reducing unwanted collisions, which improves network performance.

In some embodiments, the WiFi access point 104 and the NR-U radio unit 108 may communicate multiple buffer status reports to the controller 112 over the course of the timeslots 302A, 302B, 302C, 302D, 302E, 302F, and 302G. This sequence of buffer status reports may provide updates as to the traffic load awaiting transmission at the WiFi access point 104 and the NR-U radio unit 108. The controller 112 may schedule transmissions for the WiFi access point 104 and the NR-U radio unit 108 for a timeslot using the most recent buffer status reports from the WiFi access point 104 and the NR-U radio unit 108. For example, the controller 112 may have scheduled the NR-U radio unit 108 to transmit during the timeslot 302B using information in a buffer status report from the NR-U radio unit 108 received during the timeslot 302A. As another example, the controller 112 may have determined that the NR-U radio unit 108 should not transmit during the timeslot 302D using information in a buffer status report from the NR-U radio unit 108 received during the timeslot 302C. In this manner, the controller 112 receives additional buffer status reports from the WiFi access point 104 and the NR-U radio unit 108 and updates the transmission schedule accordingly.

In particular embodiments, the controller 112 caps or limits the number of subchannels that the NR-U radio unit 108 may use during a timeslot. For example, the controller 112 may puncture no more than two subchannels for the NR-U radio unit 108 during a timeslot. If the NR-U radio unit 108 needs more transmission scheduled, the controller 112 may puncture subchannels in additional timeslots for the NR-U radio unit 108. In this manner, the controller 112 reserves subchannels for the WiFi access point 104 during each timeslot.

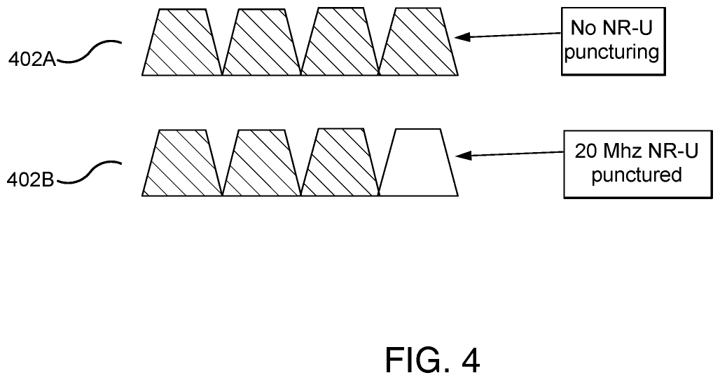

FIG. 4 illustrates an example of puncturing in the System 100 of FIG. 1. Generally, FIG. 4 shows the scheduling of transmissions of four 20-megaHertz subchannels of an 80-megaHertz channel during two timeslots 402A and 402B. During the timeslot 402A, none of the 20-megaHertz subchannels are punctured to allow an NR-U radio unit to transmit (indicated by the trapezoids with hatching in the timeslot 402A). As a result, each of the four subchannels are used by a WiFi access point for transmission. During the timeslot 402B, a 20-megaHertz subchannel of the 80-megaHertz channel is punctured to allow transmissions by an NR-U radio unit (indicated by the trapezoid with no hatching in the timeslot 402B). As a result, the NR-U radio unit is allowed to transmit using the punctured 20-megaHertz subchannel, and the remaining three subchannels are used by the WiFi access point to transmit (indicated by the trapezoids with hatching in the timeslot 402B). In this manner, the NR-U radio unit and the WiFi access point share the same channel while reducing unwanted collisions, which improves network performance.

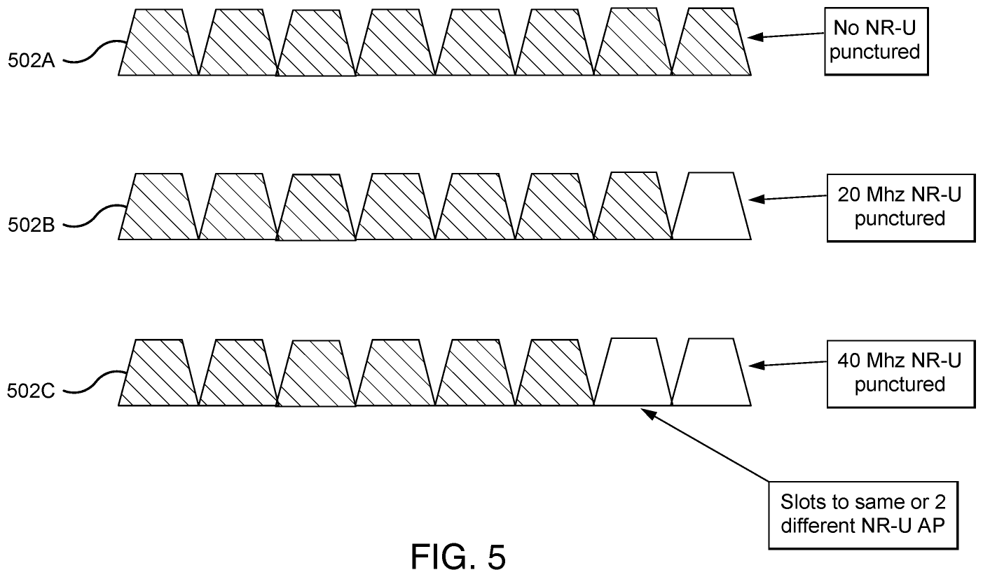

FIG. 5 illustrates an example of puncturing in the system 100 of FIG. 1. Generally, FIG. 5 shows how a 160-megaHertz channel is used for transmission during three timeslots 502A, 502B, and 502C. During the timeslot 502A, each 20-megaHertz subchannel of the 160-megaHertz channel is used by a WiFi access point for transmission (indicated by the trapezoids with hatching in the timeslot 502A). Stated differently, none of the 20-megaHertz subchannels are punctured. During the timeslot 502B, one of the 20-megaHertz subchannels is punctured to allow transmissions by an NR-U radio unit (indicated by the trapezoid with no hatching in the timeslot 502B). The remaining seven subchannels are used by the WiFi access point to transmit (indicated by the trapezoids with hatching in the timeslot 502B). As a result, the WiFi access point and the NR-U radio unit share the 160-megaHertz channel during the timeslot 502B. During the timeslot 502C, two of the 20-megaHertz subchannels are punctured to allow transmissions by one or more NR-U radio units (indicated by the trapezoids with no hatching in the timeslot 502C). For example, one NR-U radio unit may transmit using both punctured subchannels, or two NR-U radio units may each transmit using one of the punctured subchannels. The remaining six subchannels are used by the WiFi access point to transmit (indicated by the trapezoids with hatching in the timeslot 502C). As a result, the WiFi access point shares the channel with one or more NR-U radio units during the timeslot 502C. In certain embodiments, because the punctured 20-megaHertz subchannels are not used by the WiFi access point, the WiFi access point and the NR-U radio units share the channel during the timeslots 502B and 502C without unwanted collisions. As a result, the WiFi access point and the NR-U radio units may transmit during the same timeslot without causing unwanted collisions, which improves network performance.

In certain embodiments, two different NR-U radio units may use the two punctured 20-megaHertz subchannels during the timeslot 502C. The controller 112 may have received buffer status reports 206 and 208 from the NR-U radio units 108 and 110, and the controller 112 may have determined that both the NR-U radio units 108 and 110 should transmit during the timeslot 502C. In response, the controller 112 punctures two 20-megaHertz subchannels and allows the NR-U radio unit 108 to use one of the subchannels and the NR-U radio unit 110 to use the other subchannel. The controller 112 may also instruct the WiFi access point 104 to use the other remaining subchannels during the timeslot 502C. In this manner, the WiFi access point 104 and the NR-U radio units 108 and 110 share the channel during the timeslot of 502C. Additionally, the NR-U radio units 108 and 110 use different subchannels to transmit during the timeslot 502C.

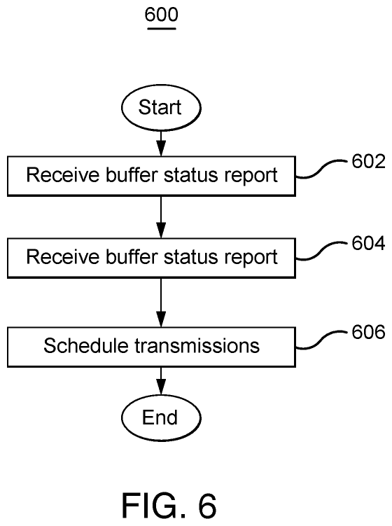

FIG. 6 is a flowchart of an example method 600 performed in the system 100 of FIG. 1. In particular embodiments, the controller 112 performs the method 600. By performing the method 600, the controller 112 coordinates transmissions of a WiFi access point 104 and a NR-U radio unit 108 so that the WiFi access point 104 and the NR-U radio unit 108 may transmit using the same channel during the same timeslot.

In block 602, the controller 112 receives a buffer status report 202 from the WiFi access point 104. The buffer status report 202 may indicate an amount of traffic awaiting transmission at the WiFi access point 104. If a large amount of traffic is awaiting transmission at the WiFi access point 104, the controller 112 may schedule additional transmissions for the WiFi access point 104 to alleviate the traffic load at the WiFi access point 104.

In block 604, the controller 112 receives a buffer status report 206 from the NR-U radio unit 108. The buffer status report 206 may indicate an amount of traffic awaiting transmission at the NR-U radio unit 108. If a large amount of traffic is awaiting transmission at the NR-U radio unit 108, the controller 112 may schedule additional transmissions for the NR-U radio unit 108 to alleviate the traffic load at the NR-U radio 108.

In block 606, the controller 112 schedules transmissions for the WiFi access point 104 and the NR-U radio unit 108 using the information in the buffer status reports 202 and 206. For example, if the buffer status report 206 indicates that the NR-U radio unit 108 has traffic awaiting transmission, the controller 112 may schedule the NR-U radio unit 108 to transmit some of the awaiting traffic using a subchannel of the channel used by the WiFi access point 104. For example, the controller 112 may instruct the NR-U radio unit 108 to use a 20-megaHertz subchannel of the channel used by the WiFi access point 104. The controller 112 may also instruct the WiFi access point 104 to refrain from using that subchannel during the timeslots when the NR-U radio unit 108 is scheduled to transmit using that subchannel. In this manner, the controller 112 prevents unwanted collisions between the WiFi access point 104 and the NR-U radio unit 108 during the timeslots when the WiFi access point 104 and the NR-U radio unit 108 transmit using the same channel, in certain embodiments.

In summary, the system 100 coordinates the transmissions of a WiFi access point 104 and a NR-U radio unit 108. The system 100 includes a controller 112 that uses buffer status reports from the WiFi access point 104 and the NR-U radio unit 108 to schedule the transmissions from the WiFi access point 104 and the NR-U radio unit 108. When these transmissions are scheduled to occur in the same time slot and using the same channel, the controller 112 may schedule the NR-U radio unit 108 to transmit using a portion of the sub-channels (e.g., some of the 20 MHz sub-channels) of the channel. The remaining sub-channels are allotted to the WiFi access point 104. When the NR-U radio unit 108 does not need to transmit, all sub-channels may be allocated to the WiFi access point 104. As a result, the controller 112 allows both the WiFi access point 104 and the NR-U radio unit 108 to transmit using the same channel during the same time slot without causing unwanted collisions, which improves network performance in certain embodiments.

Check claims for support

Check disclosure for details

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method comprising:
receiving a first buffer status report from a wireless fidelity (WiFi) access point;
receiving a second buffer status report from a first New Radio Unlicensed (NR-U) radio unit; and
scheduling, based at least in part on the first buffer status report and the second buffer status report, both the WiFi access point and the first NR-U radio unit to transmit during a first time slot using a channel, wherein the WiFi access point transmits using a first sub-channel of the channel and the first NR-U radio unit transmits using a second sub-channel of the channel different from the first sub-channel.

2. The method of claim 1, further comprising:
receiving a third buffer status report from the first NR-U radio unit;
determining, based at least in part on the third buffer status report, that the first NR-U radio unit is refraining from transmitting during a second time slot; and
in response to determining that the first NR-U radio unit is refraining from transmitting during the second time slot, scheduling the WiFi access point to transmit during the second time slot using the first sub-channel and the second sub-channel.

3. The method of claim 1, wherein scheduling both the WiFi access point and the first NR-U radio unit to transmit during the first time slot is further based at least in part on an amount of latency sensitive traffic at the WiFi access point and an amount of latency sensitive traffic at the first NR-U radio unit.

4. The method of claim 1, wherein the first NR-U radio unit transmits further using a third sub-channel of the channel different from the first sub-channel and the second sub-channel.

5. The method of claim 1, wherein the first NR-U radio unit is capped to using a portion of the sub-channels of the channel when transmitting during the first time slot.

6. The method of claim 1, further comprising:
receiving a third buffer status report from a second NR-U radio unit; and
scheduling, based at least in part on the third buffer status report, the second NR-U radio unit to transmit during the first time slot using a third sub-channel of the channel different from the first sub-channel and the second sub-channel.

7. The method of claim 1, further comprising communicating a message to the WiFi access point that instructs the WiFi access point to refrain from transmitting during the first time slot using the second sub-channel.

8. An apparatus comprising:
a memory; and
a processor communicatively coupled to the memory, the processor configured to:
receive a first buffer status report from a WiFi access point;
receive a second buffer status report from a first NR-U radio unit; and
schedule, based at least in part on the first buffer status report and the second buffer status report, both the WiFi access point and the first NR-U radio unit to transmit during a first time slot using a channel, wherein the WiFi access point transmits using a first sub-channel of the channel and the first NR-U radio unit transmits using a second sub-channel of the channel different from the first sub-channel.

9. The apparatus of claim 8, wherein the processor is further configured to:
receive a third buffer status report from the first NR-U radio unit;
determine, based at least in part on the third buffer status report, that the first NR-U radio unit is refraining from transmitting during a second time slot; and
in response to determining that the first NR-U radio unit is refraining from transmitting during the second time slot, schedule the WiFi access point to transmit during the second time slot using the first sub-channel and the second sub-channel.

10. The apparatus of claim 8, wherein scheduling both the WiFi access point and the first NR-U radio unit to transmit during the first time slot is further based at least in part on an amount of latency sensitive traffic at the WiFi access point and an amount of latency sensitive traffic at the first NR-U radio unit.

11. The apparatus of claim 8, wherein the first NR-U radio unit transmits further using a third sub-channel of the channel different from the first sub-channel and the second sub-channel.

12. The apparatus of claim 8, wherein the first NR-U radio unit is capped to using a portion of the sub-channels of the channel when transmitting during the first time slot.

13. The apparatus of claim 8, wherein the processor is further configured to:
receive a third buffer status report from a second NR-U radio unit; and
schedule, based at least in part on the third buffer status report, the second NR-U radio unit to transmit during the first time slot using a third sub-channel of the channel different from the first sub-channel and the second sub-channel.

14. The apparatus of claim 8, wherein the processor is further configured to communicate a message to the WiFi access point that instructs the WiFi access point to refrain from transmitting during the first time slot using the second sub-channel.

15. A non-transitory computer readable medium storing instructions, that when executed by a processor, cause the processor to:
receive a first buffer status report from a WiFi access point;
receive a second buffer status report from a first NR-U radio unit; and
schedule, based at least in part on the first buffer status report and the second buffer status report, both the WiFi access point and the first NR-U radio unit to transmit during a first time slot using a channel, wherein the WiFi access point transmits using a first sub-channel of the channel and the first NR-U radio unit transmits using a second sub-channel of the channel different from the first sub-channel.

16. The medium of claim 15, wherein the instructions further cause the processor to:
receive a third buffer status report from the first NR-U radio unit;
determine, based at least in part on the third buffer status report, that the first NR-U radio unit is refraining from transmitting during a second time slot; and
in response to determining that the first NR-U radio unit is refraining from transmitting during the second time slot, schedule the WiFi access point to transmit during the second time slot using the first sub-channel and the second sub-channel.

17. The medium of claim 15, wherein scheduling both the WiFi access point and the first NR-U radio unit to transmit during the first time slot is further based at least in part on an amount of latency sensitive traffic at the WiFi access point and an amount of latency sensitive traffic at the first NR-U radio unit.

18. The medium of claim 15, wherein the first NR-U radio unit transmits further using a third sub-channel of the channel different from the first sub-channel and the second sub-channel.

19. The medium of claim 15, wherein the first NR-U radio unit is capped to using a portion of the sub-channels of the channel when transmitting during the first time slot.

20. The medium of claim 15, wherein the instructions further cause the processor to:
receive a third buffer status report from a second NR-U radio unit; and
schedule, based at least in part on the third buffer status report, the second NR-U radio unit to transmit during the first time slot using a third sub-channel of the channel different from the first sub-channel and the second sub-channel.
